(19) United States
(12) Patent Application Publication
(10) Pub. No.: US 2024/0225392 A9
(43) Pub. Date: Jul. 11, 2024

(54) FILTER ASSEMBLY FOR A VACUUM CLEANER

(71) Applicant: Dyson Technology Limited, Wiltshire (GB)

(72) Inventors: Benjamin James HOVELL, Gloucester (GB); Kian Kiong PANG, Kulai (MY)

(73) Assignee: Dyson Technology Limited, Wiltshire (GB)

(21) Appl. No.: 18/278,687

(22) PCT Filed: Feb. 10, 2022
(86) PCT No.: PCT/GB2022/050358

§ 371 Date: Aug. 24, 2023

(30) Foreign Application Priority Data
Mar. 30, 2021 (GB) 2104472.2

(51) Int. Cl. A47L 9/19; A47L 9/12; A47L 9/28

(52) U.S. Cl. CPC A47L 9/19; A47L 9/12; A47L 9/2857

(57) ABSTRACT

A filter assembly for use in a vacuum cleaner includes a filter medium including a state-changing material which changes state in dependence on the quantity of liquid to which the filter medium is exposed to provide a first status indication to a user that the filter assembly is suitable for use in the vacuum cleaner when the state-changing material is in a first state and a second status indication to the user that the filter assembly is not suitable for use in the vacuum cleaner when the state-changing material is in a second state.

The present invention relates to a serviceable part for an electrical appliance comprising a means for indicating a status of the serviceable part. Aspects of the invention relate to a serviceable part, a serviceable filter assembly and an electrical appliance. In particular, but not exclusively, the invention relates to a serviceable filter assembly for use in an electrical appliance, such as a vacuum cleaner.

A vacuum cleaning appliance or, more simply, “vacuum cleaner”, typically comprises a main body which is equipped with a suction motor, a dust separator, and a cleaner head connected to the dust separator usually by a separable coupling. The dust separator is the main mechanism by which the vacuum cleaner removes dirt and debris from the airflow through the machine, and this applies whether the dust separator relies on a cyclonic separation system or otherwise.

Although dust separators are generally very efficient at removing dirt and debris from the airflow, fine particles remain in the airflow that exits the dust separator and travels towards the suction motor. It is important that the suction motor is protected from these fine particles as they can be potentially damaging to some of its components. It is also important to make the exhaust airflow that is discharged from the vacuum cleaner as clean as possible. Thus, typically, a vacuum cleaner includes two filters: a first filter, also called a “pre-motor filter” or “pre-filter”, which is located in the airflow through the machine downstream of the dust separator but upstream of the suction motor; and a second filter, also called a “post-motor filter” or “post-filter”, that is located in the airflow downstream of the suction motor, before the airflow exhausts from the machine.

It is known to house the pre-motor filter medium in a filter assembly which can be removed easily by the user for cleaning purposes. Typically, once the filter assembly is removed the filter medium for the pre-filter can be removed from the assembly, washed, and dried, and then replaced in the assembly. It remains a challenge however to ensure that the user handles the filter medium correctly once it has been removed and that once washed the filter medium is thoroughly dried before it is re-inserted into the filter assembly. For example, any moisture remaining in the filter medium once it has been re-inserted into the filter assembly can cause problems due to its location relative to the electronic components of the filter assembly, so that it is desirable to avoid inserting a filter medium which is not fully dried into the assembly. Further, a moisture remaining on the filter medium can cause mould to grow on the filter medium and cause an unpleasant odour.

It is an object of the invention to address the aforementioned problem.

### SUMMARY OF THE INVENTION

According to a first aspect of the present invention there is provided a serviceable part for use in an electrical appliance, the serviceable part comprising a medium comprising a state-changing material which changes state in dependence on the quantity of liquid to which the medium is exposed to provide a first status indication to a user that the serviceable part is suitable for use in the electrical appliance when the state-changing material is in a first state and a second status indication to the user that the serviceable part is not suitable for use in the electrical appliance when the state-changing material is in a second state.

In one embodiment, the state-changing material is a hydrochromic material which changes state depending on the quantity of water to which the medium is exposed.

Typically, the state-changing material may be a reversible state-changing material so that it can change back and forth between the first and second states in dependence on the quantity of liquid (e.g. water) to which the medium is exposed. This ensures that the medium can be cleaned or washed multiple times, and on each occasion after cleaning or washing the user is provided with an indication if the filter assembly is not dry enough to be reassembled safely into the electrical appliance.

By way of example, the state-changing material may take the form of an ink, gel or dye.

In one embodiment, the first and second status indications are visual indications. For example, the first and second status indications may be of different colour and/or transparency and/or opacity.

At least one of the first and second status indications may include at least one of a textual, graphical, symbolic and/or pictorial indication of the state of the medium. A textual indication may typically display the words “do not use” or “not suitable for use” to the user servicing the part.

In one embodiment, the medium is a washable filter medium, such as one which may be washed with water, and the state-changing material is a hydrochromic material.

For example, the filter medium may comprise fibres of material, at least some of which are impregnated, soaked, saturated, and/or coated with the state-changing material.

It may be preferably to impregnate, soak, saturate or coat just a portion of the fibres of the filter medium, rather than all of the fibres of the filter medium, for example for reasons of economy. Typically those fibres which are treated with the state-changing material are treated in such a way as to display a textual, graphical, symbolic and/or pictorial indication to provide an indication to the user of the state of the serviceable part.

According to a second aspect of the invention, there is provided an electrical appliance comprising the aforementioned serviceable part.

The electrical appliance may include a means for sensing the state of the state-changing material and for providing an output to the user based on the sensed state.

For example, a display may be provided on the electrical appliance for displaying the output. In addition, or alternatively, the sensor assembly may include a speaker for outputting an audible output.

The serviceable part is preferably a filter assembly for a vacuum cleaner and so in a third aspect the present invention provides a filter assembly for a vacuum cleaner, the filter assembly comprising a filter medium having fibres integrated with a state-changing material which changes state in dependence on the quantity of liquid to which the filter medium is exposed to provide a first status indication to a user that the filter assembly is suitable for use in the vacuum cleaner when the state-changing material is in a first state and a second status indication to the user that the filter assembly is not suitable for use in the vacuum cleaner when the state-changing material is in a second state.

In a fourth aspect the present invention provides a vacuum cleaner comprising a filter assembly as aforementioned.

It will be appreciated that preferred and/or optional features of each aspect of the invention may be incorporated alone, or in appropriate combination, in the other aspects of the invention also.

### BRIEF DESCRIPTION OF THE DRAWINGS

In order that the present invention may be more readily understood, an embodiment of the invention will now be described, by way of example, with reference to the accompanying drawings, in which:

FIG. 1 is a perspective view of a dust separation device for a vacuum cleaner with which a serviceable filter assembly of the invention may be used, with the dust separation device in an in-use position;

FIG. 2 is a perspective view of the dust separation device in FIG. 1, when in a docked or stowed position;

FIG. 3 is a perspective view of a filter medium for use in the filter assembly for the dust separation device shown in FIGS. 1 and 2;

FIG. 4 is a perspective view of the dust separation device in FIGS. 1 and 2, to illustrate the serviceable filter assembly of FIG. 3 being removed from the dust separation device;

FIG. 5 is a section view of a part of the dust separation device in FIGS. 1, 2 and 4 when in the docked or stowed position (as in FIG. 2), to illustrate a water path through the filter assembly;

FIG. 6 is a perspective view, similar to FIG. 4, to illustrate an alternative embodiment of the dust separation device; and

FIG. 7 illustrates an example of a notification on the filter assembly which may be provided to indicate the state of the filter medium.

### DETAILED DESCRIPTION OF PREFERRED EMBODIMENTS

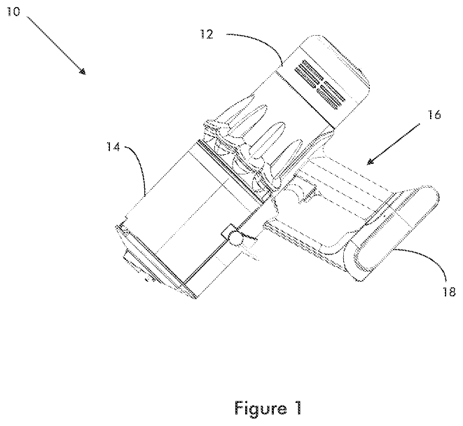

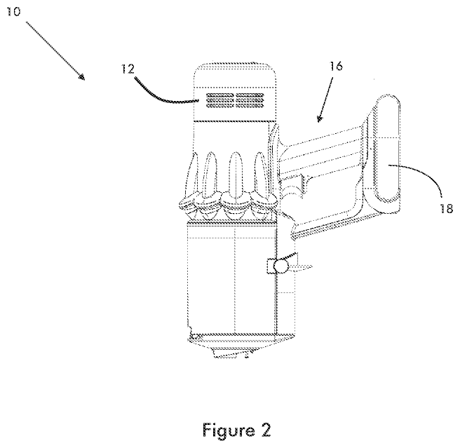

FIGS. 1 and 2 show a perspective view of a dust separation device, referred to generally as 10, with which a filter assembly 12 of an embodiment of the invention is used. The dust separation device 10 forms a part of a vacuum cleaner which includes, at one end of an elongate section (referred to as the wand), a cleaner head (not shown). The dust separation device 10 is located at the other end of the wand to the cleaner head.

The dust separation device 10 includes a device housing 14 having a handle 16 for manipulation by the user. Typically, the handle 16 houses a battery pack inside one handle section 18 which may contain one or more replaceable or rechargeable batteries for powering the dust separation device 10. The device housing 14 houses various components of the dust separation device 10, as is known in the art, including a cyclone assembly and a brushless electric motor (not shown). The dust separation device 10 utilises cyclonic separation to separate dirt and debris from an airflow through the device to enable the cleaning of a surface as the cleaner head is swept over the surface. The brushless electric motor is a direct current motor which is operated on a switched reluctance principle and is controlled by means of a printed circuit board (PCB) (not visible in FIG. 1) which receives power from the battery pack 18.

The filter assembly 12 provides a pre-motor filter stage for the dust separation device 10 and connects to one end of the device housing 14 in a removable manner. The other end of the device housing 14 connects to the wand (not shown).

In FIG. 1, the dust separation device 10 is shown in a typical in-use orientation of the vacuum cleaner in which the longitudinal axis of the dust separation device is at an angle to the vertical direction. The user grasps the handle 16 of the dust separation device 10 and manoeuvres the device so that the cleaner head at the end of the wand is moved back and forth across the surface to be cleaned. When not in use, the dust separation device 10 is stowed in a docked or stowed position, as shown in FIG. 2, in which the longitudinal axis of the dust separation device is aligned with the vertical direction. This orientation is particularly convenient as it lends itself to stowing of the vacuum cleaner against a wall or in a cupboard to minimise intrusion into open space.

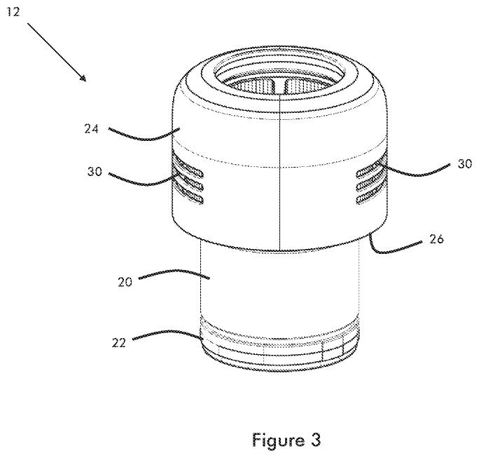

As shown in FIG. 3, the filter assembly 12 comprises an annular filter medium 20 having upper and lower ends, with the lower end being received in an annular support 22. At the other end (the upper end), the filter medium 20 extends into a vented casing 24 which has an open end 26 for receiving the filter medium 20. In some embodiments, at the other end of the casing 24, a closed base end is provided. The vented casing 24 has an enlarged diameter compared to the diameter of the filter medium 20 and comprises a plurality of elongate vents 30 in a side wall of the casing 24. The vents 30 are configured to expel filtered air.

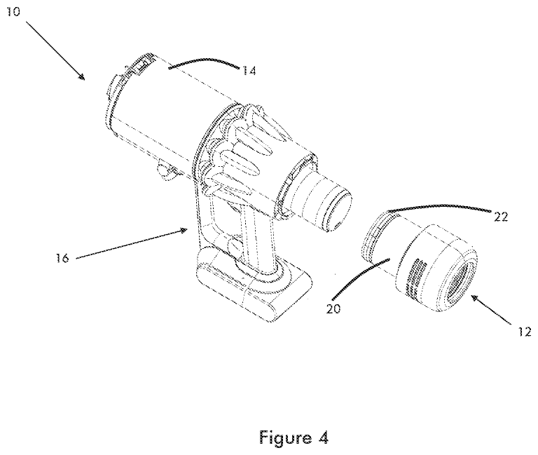

In order to clean the pre-motor filter assembly 12 it is necessary to first disconnect the filter assembly 12 from the dust separation device 10, as shown in FIG. 4. It is a known problem that during use the filter medium 20 tends to become blocked with dirt and debris and therefore regular cleaning is required to ensure effective operation and prolonged service life for the vacuum cleaner. When the filter assembly 12 is removed from the dust separation device 10, upturning the filter medium 20 from the orientation shown in FIG. 3 allows the filter medium 20 to be filled with water through the open annular support 22. As water fills the upturned filter assembly 12, it can be swirled around the filter medium to clean it, typically running the filter medium 20 under a running water tap or immersing it in water. The filter medium 20 should then be dried fully before it is reassembled into the filter assembly 12, following which the filter assembly 12 can be re-connected to the dust separation device 10.

The problem which can be experienced in the dust separation device 10 arises when the filter medium of the filter assembly 12 is not fully dried before it is re-assembled with the dust separation 10 and the vacuum cleaner is stored in the stowed position of FIG. 2.

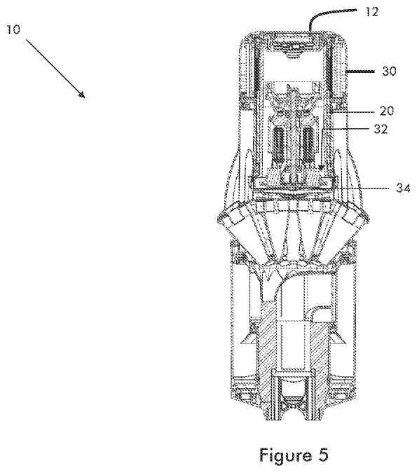

Referring also to FIG. 5, which shows the internal parts of the dust separation device and the filter assembly 12, when the dust separation device 10 is in the stowed position the PCB 34 is positioned directly beneath the filter member 20 and therefore, under the force of gravity, any water which remains within the filter medium 20 after washing is able to follow a water path 32 downwards through the filter assembly, impinging on the PCB 34. To avoid failures resulting from the exposure of the PCB 34 to water or other cleaning liquid, it is therefore imperative that the filter member 20 is completely dry before it is re-assembled into the filter assembly 12.

To this end, the inventors have realised that by introducing into the filter assembly 12 a means for indicating to the user servicing the filter assembly 12 that the filter member 20 is not fully dry and is not suitable for replacement into the appliance, allows failures of this nature to be substantially avoided. The invention resides in the use of a hydrochromic material which changes state depending on the amount of water to which it is exposed. By incorporating the hydrochromic material into the filter medium 20, it is possible to indicate to the user when the filter medium 20 is in a suitably dry state to be replaced safely without causing water damage to the PCB 34 when the vacuum cleaner is in the stowed position.

The fibres of the filter medium 20 may be integrated with a hydrochromic material in the form of an ink or a dye by impregnating, soaking, saturating or otherwise infusing the fibres with the hydrochromic material. Alternatively, the fibres may be coated with the hydrochromic material. In this way, when the filter medium 20 is removed from the filter assembly 12 and washed, exposing the hydrochromic to the washing solution, the hydrochromic material changes state in a manner which is visible to the user. The appearance of the hydrochromic material can be used to indicate to the user when the filter member 20 has dried sufficiently to be replaced safely into the suction device.

The whole of the filter medium 20 may be impregnated, soaked, saturated or coated with hydrochromic material so that the appearance of the whole filter medium 20 changes depending on the extent to which it is exposed to water. When reassembling the filter medium 20 with the dust separation device 10 after servicing, it is then immediately evident to the user whether the filter medium 20 is sufficiently dry for safe use by observing its colour. By way of example, the filter medium 20 may appear blue when dry but may change to a red colour when wet, and instructions are given to the user that when the filter medium 20 is red in colour it is not sufficiently dry to be used but when it is blue it is suitable to be used.

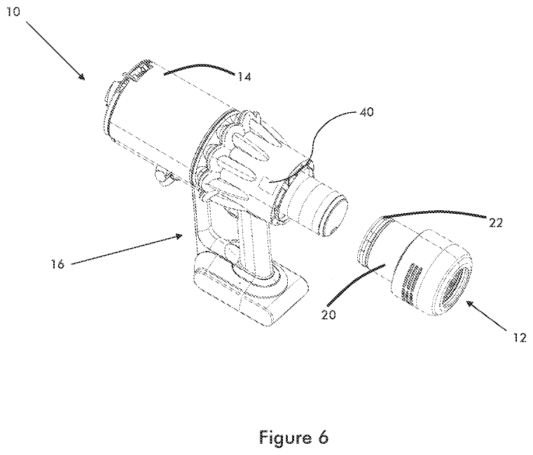

Referring to FIG. 6, the casing 14 of the dust separation 10 may be provided with an opening 40 to define a viewing port for the filter medium 20 which is then clearly visible to the user once the filter assembly 12 has been replaced on the dust separation device with a clean filter medium 20. In this way the user can clearly see through the viewing port 40 whether the colour of the filter medium 20 indicates that it is not fully dry. The viewing port 40 is positioned so that when the vacuum cleaner is in the stowed position, the filter medium 20 is clearly visible through the port 40. In this example it is only necessary for a small section of the filter medium 20 that is visible through the viewing port 40 to be treated with the hydrochromic material. Of course, in this scenario it should be evident to the user before replacing the filter assembly 12 that the filter medium 20 is not fully dry by observing the colour of the filter medium 20 as it is handled, before assembly with the dust separation device 10, but the provision of the viewing port 40 reduces any risk of this observation being ignored by ensuring a clear display of the colour of the filter medium 20 through the viewing port 40 after assembly.

As an alternative to impregnating, saturating, soaking or coating the whole of the filter medium with hydrochromic material, only a section of the filter medium may be treated in this way. If the viewing port 40 is provided in the casing 14 then ideally the section of the filter medium 20 that is treated with hydrochromic material is that section which is visible through the viewing port 40.

Hydrochromic materials can either be reversible in nature, or permanent in nature, and for the present invention there is an advantage to using a hydrochromic material that is reversible so that it can switch between the first state (e.g. when it is of one colour) and the second state (e.g. when it is of another colour) depending on the extent to which the hydrochromic material is exposed to water. This means that once the filter medium 20 has been washed and dried and returns to its initial first state (colour 1), if exposed to water again it will change to the second state (colour 2), and back again once it dries again (colour 1). The hydrochromic material can therefore switch between states multiple times, depending on the extent to which it is exposed to water on each wash, and the colour that is observed by the user is an indicator of the suitability of the filter assembly 14 for use after washing.

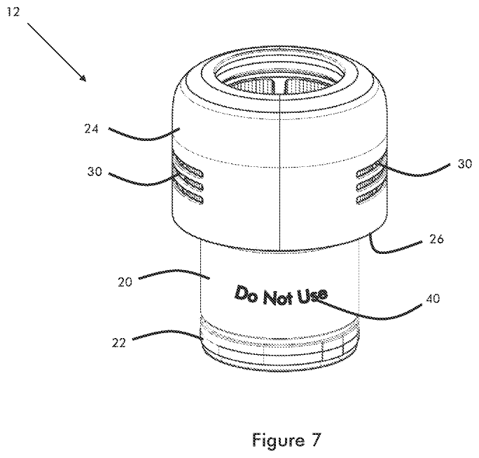

FIG. 7 illustrates another example of how the hydrochromic material may be used to display a message to the user that the filter medium 20 is not sufficiently dry for the filter assembly to be assembled with the dust separation device 10. In this example the hydrochromic material may be provided within or on only a small section of the filter medium and so that it displays a textual indication in the form of a message 42 stating “DO NOT USE” when the filter medium is too wet. This is achieved by impregnating, saturating, soaking or coating the fibres of the filter medium with the hydrochromic material to form a pattern of letters which spell out the required message.

It is convenient if the message is visible to the user through the viewing port 40 in the device housing 14, although the message can also be observed when the user is handling the filter assembly 14 to reassemble it with the dust separation device 10.

Instead of providing a textual indication as a message to the user, the hydrochromic material may be provided only within or on a small section of the filter medium 20 to display an image in the form of a warning symbol to indicate that the filter medium 20 is too wet to be replaced in the device. The section of the filter medium 20 to which the hydrochromic material is applied is again selected so as to align with the viewing port 40 in the device housing. Again, this provides a clear indication to the user through the viewing port 40 as to whether the filter medium is dry enough to be replaced.

As an alternative to changing colour when wet, other hydrochromic materials change their opacity or transparency in dependence on the amount of water to which they are exposed. For example, when some hydrochromic materials become wet they take up water and become transparent. If a message is provided on a section of the filter medium (e.g. in the form of a textual indication or a graphical symbol) and the hydrochromic material is coated onto the section to which the message is applied, the message is revealed when the hydrochormic material is exposed to water and becomes transparent: when the hydrochromic material dries the material becomes opaque and the message cannot be seen. The filter medium 20 may therefore have a message applied using an ink, gel or dye which is only revealed when the overlaid hydrochromic material is exposed to water and becomes transparent. Typically the message may read “DO NOT USE” or “NOT SUITABLE FOR USE”, or some other graphical or pictorial warning symbol which indicates to the user that the filter medium is not dry enough to be safely installed into the appliance.

Graphical and/or pictorial indications may be provided over the whole of the filter medium and need not be limited to one section. These may be used alone or in combination with textual indications to the user about the suitability of the filter medium 20 for use.

Other materials change state when exposed to fluids other than water-based fluids, and it is also possible to integrate, impregnate or coat at least some of the fibres of the filter medium 20 with these materials, if the filter medium is to be washed with something other than a water-based solution.

In order to form the filter medium 20, a sheet of filter medium may be screen printed with hydrochromic material with sections of the sheet then rolled to form the annular structure shown in FIG. 3. In other embodiments, the hydrochromic material may be sprayed, pasted or otherwise painted onto the filter medium 20 in the required sections to form the necessary messaging.

In other embodiments (not shown), the state-changing material need not be used to give a direct indication to the user on the state of the washed filter medium 20, but the filter assembly 12 may include a means for sensing the state of the state-changing material integrated with the filter medium 20 and for providing an output to the user based on the sensed state. For example, the filter assembly 12 may include a sensor which determines the state of the state-changing material and outputs a signal depending on the determined state. If the state-changing material is a hydrochromic material, the sensor may determine the colour or opacity of the material. The output may be notified to the user via a display on the vacuum cleaner to which the output from the sensor is provided when the parts 10, 12 are re-assembled together. In embodiments, the output may cause the motor to switch off.

It will be appreciated that various other modifications to the invention may be made within departing from the scope of the invention as set out in the accompanying claims.

1. A filter assembly for a vacuum cleaner, the filter assembly comprising a filter medium having fibres integrated with a state-changing material which changes state in dependence on the quantity of liquid to which the filter medium is exposed to provide a first status indication to a user that the filter assembly is suitable for use in the vacuum cleaner when the state-changing material is in a first state and a second status indication to the user that the filter assembly is not suitable for use in the vacuum cleaner when the state-changing material is in a second state.

2. The filter assembly as claimed in claim 1, wherein the state-changing material is a hydrochromic material which changes state depending on the quantity of water to which the filter medium is exposed.

3. The filter assembly as claimed in claim 1, wherein the state-changing material is a reversible state-changing material so that it can switch back and forth between the first and second states in dependence on the quantity of liquid to which the filter medium is exposed.

4. The filter assembly as claimed in claim 1, wherein the state-changing material takes the form of an ink, gel or dye.

5. The filter assembly as claimed in claim 1, wherein the first and second status indications are visual indications.

6. The filter assembly as claimed in claim 5, wherein the first and second status indications are of different colour and/or transparency and/or opacity.

7. The filter assembly as claimed in claim 1, wherein at least one of the first and second status indications includes at least one of a textual, graphical, symbolic and/or pictorial indication.

8. The filter assembly as claimed in claim 1, wherein the filter medium is washable.

9. The filter assembly as claimed in claim 8, wherein the filter medium comprises fibres of material, at least some of which are impregnated, saturated, soaked and/or coated with the state-changing material.

10. A vacuum cleaner comprising the filter assembly as claimed in claim 1.

11. The vacuum cleaner as claimed in claim 10, further comprising a sensor assembly for sensing the state of the state-changing material and for providing an output to the user based on the sensed state.

12. The vacuum cleaner as claimed in claim 11, wherein the sensor assembly includes a display for displaying the output.

13. The vacuum cleaner as claimed in claim 11,
wherein the sensor assembly includes a speaker for providing an audible output.

14. The vacuum cleaner as claimed in claim 13, having a stowed position in which it is stored and an in-use position in which it is used to clean surfaces, the vacuum cleaner comprising a printed circuit board including a controller for the vacuum cleaner, wherein the printed circuit board resides beneath the filter assembly when the vacuum cleaner is in the stowed position.
